(19) United States
(12) Patent Application Publication
(10) Pub. No.: US 2021/0374978 A1
(43) Pub. Date: Dec. 2, 2021

(54) CAPTURING ENVIRONMENTAL SCANS USING ANCHOR OBJECTS FOR REGISTRATION

(71) Applicant: FARO Technologies, Inc., Lake Mary, FL (US)

(72) Inventors: Daniel Döring, Ditzingen (DE); Gerrit Hillebrand, Waiblingen (DE); Martin Ossig, Tamm (DE); Rasmus Debitsch, Fellbach (DE)

(21) Appl. No.: 17/330,721

(22) Filed: May 26, 2021

Related U.S. Application Data
(60) Provisional application No. 63/066,445, filed on Aug. 17, 2020.
(60) Provisional application No. 63/031,877, filed on May 29, 2020.

(51) Int. Cl. G06T 7/33; G06T 7/73; G06T 3/00; G01S 17/42; G01S 17/894

(52) U.S. Cl. CPC G06T 7/33; G06T 7/73; G06T 3/0081; G06T 2200/24; G01S 17/894; G06T 2207/30204; G06T 2207/10028; G01S 17/42

(57) ABSTRACT

According to one or more embodiments, a system includes a scanner device configured to capture a set of point clouds comprising 3D points. The system further includes one or more processors that detect, during the capture of the set of point clouds, at least one first anchor object in a first part of a first point cloud. The first part belongs to a first time interval centered at time t1. A second anchor object is detected in a second part of the first point cloud, the second part belonging to second time interval centered at time t2. Further, at least one correspondence is identified between the first anchor object and the second anchor object. The first part of the first point cloud is aligned with the second part of the first point cloud based on the at least one correspondence between the first anchor object and the second anchor object.

### CROSS-REFERENCE

This application claims the benefit of U.S. patent application Ser. No. 63/031,877 filed May 29, 2020 and U.S. patent application Ser. No. 63/066,445 filed Aug. 17, 2020, the disclosures of which are incorporated by reference herein in its entirety.

### BACKGROUND

The present application is directed to a system that optically scans an environment, such as a building, and in particular to a mobile scanning system that generates two-dimensional (2D) and three-dimensional (3D) scans of the environment.

A 3D triangulation scanner, also referred to as a 3D imager, is a portable device having a projector that projects light patterns on the surface of an object to be scanned. One (or more) cameras, having a predetermined positions and alignment relative to the projector, records images of the light pattern on the surface of an object. The three-dimensional coordinates of elements in the light pattern can be determined by trigonometric methods, such as by using triangulation. Other types of 3D measuring devices may also be used to measure 3D coordinates, such as those that use time of flight techniques (e.g., laser trackers, laser scanners or time of flight cameras) for measuring the amount of time it takes for light to travel to the surface and return to the device.

It is desired to have a handheld 3D measurement device that is easier to use and that gives additional capabilities and performance. Technical challenges with such scanners include that, during the scanning process, the scanner acquires, at different times, a series of images of the patterns of light formed on the object surface. These multiple images are then registered relative to each other so that the position and orientation of each image relative to the other images are known. Where the scanner is handheld, various techniques have been used to register the images. One common technique uses features in the images to match overlapping areas of adjacent image frames. This technique works well when the object/environment being measured has many features relative to the field of view of the scanner. However, if the object/environment contains a relatively large flat or curved textureless surface, the images may not properly register relative to each other.

Today, processing capability of a handheld scanner is limited by the capability of processors within the handheld scanner. Faster processing of scan data would be desirable. Greater flexibility and speed in post-processing scan data would also be desirable.

Accordingly, while existing handheld 3D triangulation scanners are suitable for their intended purpose, the need for improvement remains.

### BRIEF DESCRIPTION

According to one or more embodiments, a system includes a scanner device configured to capture a set of point clouds comprising 3D points. The system further includes one or more processors that are operable to detect, during the capture of the set of point clouds, at least one first anchor object in a first part of a first point cloud, the first part belonging to first time interval centered at time t1. The one or more procesors also detect at least one second anchor object in a second part of the first point cloud, the second part belonging to second time interval centered at time t2. The one or more procesors further identify at least one correspondence between the first anchor object and the second anchor object. The one or more procesors further align the first part of the first point cloud with the second part of the first point cloud based on the at least one correspondence between the first anchor object and the second anchor object.

According to one or more embodiments, a method for a scanner device to capture a set of point clouds, each of the point clouds comprising 3D points includes detecting, during the capture of the set of point clouds, at least one first anchor object in a first part of a first point cloud, the first part belonging to first time interval centered at time t1. The method further includes detecting at least one second anchor object in a second part of the first point cloud, the second part belonging to second time interval centered at time t2. The method further includes identifying at least one correspondence between the first anchor object and the second anchor object. The method further includes aligning the first part of the first point cloud with the second part of the first point cloud based on the at least one correspondence between the first anchor object and the second anchor object.

According to one or more embodiments, a computer program product includes a memory device having one or more computer executable instructions stored thereon, the computer executable instructions when executed by one or more processors cause the one or more processors to perform a method for a scanner device to capture a set of point clouds, each of the point clouds comprising 3D points. The method includes detecting, during the capture of the set of point clouds, at least one first anchor object in a first part of a first point cloud, the first part belonging to first time interval centered at time t1. The method further includes detecting at least one second anchor object in a second part of the first point cloud, the second part belonging to second time interval centered at time t2. The method further includes identifying at least one correspondence between the first anchor object and the second anchor object. The method further includes aligning the first part of the first point cloud with the second part of the first point cloud based on the at least one correspondence between the first anchor object and the second anchor object.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 depicts a system for scanning an environment according to one or more embodiments of the present disclosure;

FIG. 2 schematically illustrates an example scenario in which an offset (referred to as “drift”) is continuously introduced into the scan data;

FIG. 3 illustrates the accumulation of errors and inefficiencies as a scanner captures data of surrounding environment;

FIG. 4 depicts a flowchart for setting anchor objects and using them for registration improvements according to one or more embodiments;

FIG. 5A depicts an example anchor object according to one or more embodiments;

FIG. 5B depicts an example guidance provided to scan an anchor object during scanning according to one or more embodiments;

FIG. 6 is a view of a user interface of a scanner in accordance with an embodiment of the invention;

FIG. 7 depicts a comparison between scans that are captured with and without anchor objects, respectively, according to one or more embodiments;

FIG. 8 is a front perspective view of a 3D triangulation scanner according to an embodiment of the disclosure;

FIG. 9 is a rear perspective view of the 3D triangulation scanner according to an embodiment of the disclosure;

FIG. 10A and FIG. 10B are block diagrams of electronics coupled to the triangulation scanner according to an embodiment of the disclosure;

FIG. 11 illustrates a method of interconnecting a mobile PC with a mobile display using USB tethering according to an embodiment of the disclosure;

FIG. 12 is a schematic representation of a triangulation scanner having a projector and a camera according to an embodiment of the disclosure;

FIG. 13A is a schematic representation of a triangulation scanner having a projector and two cameras according to an embodiment of the disclosure;

FIG. 13B is a perspective view of a triangulation scanner having a projector, two triangulation cameras, and a registration camera according to an embodiment of the disclosure;

FIG. 14 is a schematic representation illustrating epipolar terminology;

FIG. 15 is a schematic representation illustrating how epipolar relations may be advantageously used in when two cameras and a projector are placed in a triangular shape according to an embodiment of the disclosure;

FIG. 16 illustrates a system in which 3D coordinates are determined for a grid of uncoded spots projected onto an object according to an embodiment of the disclosure; and

FIG. 17 depicts a computing system that can implement one or more embodiments of the present disclosure.

The detailed description explains embodiments of the invention, together with advantages and features, by way of example, with reference to the drawings.

### DETAILED DESCRIPTION

Embodiments of the present disclosure provide technical solutions to technical challenges in existing environment scanning systems. The scanning systems can capture two-dimensional or three-dimensional (3D) scans. Such scans can include 2D maps, 3D point clouds, or a combination thereof. The scans can include additional components, such as annotations, images, textures, measurements, and other details.

Embodiments of the present disclosure provide a hand-held scanning platform that is sized and weighted to be carried by a single person. Embodiments of the present disclosure provide for a mobile scanning platform that may be used to scan an environment in an autonomous or semi-autonomous manner to generate a map of the environment.

Typically, when capturing a three-dimensional (3D) coordinates of points in an environment, several scans are captured by a scanner system (“scanner”), which are then combined or “stitched” to generate the map. Sometimes the collection of 3D coordinates is referred to as a “point cloud” since when it is visually displayed the 3D coordinates are represented as points. 3D points and images recorded with a single shot of a scanner can be referred to as a “frame”. A “scan” is a sequence of recorded frames. For completing such scans a scanner, such as the FARO® SCANPLAN®, FARO® SWIFT®, FARO® FREESTYLE®, or any other scanning system incrementally builds the point cloud of the environment, while the scanner is moving through the environment. In one or more embodiments of the present invention, the scanner simultaneously tries to localize itself on this map that is being generated. An example of a handheld scanner is described in U.S. patent application Ser. No. 15/713,931, the contents of which is incorporated by reference herein in its entirety. This type of scanner may also be combined with a another scanner, such as a time of flight scanner as is described in commonly owned U.S. patent application Ser. No. 16/567,575, the contents of which are incorporated by reference herein in its entirety. It should be noted that the scanners listed above are just examples and that the type of scanner used in one or more embodiments does not limit the features of the technical solutions described herein.

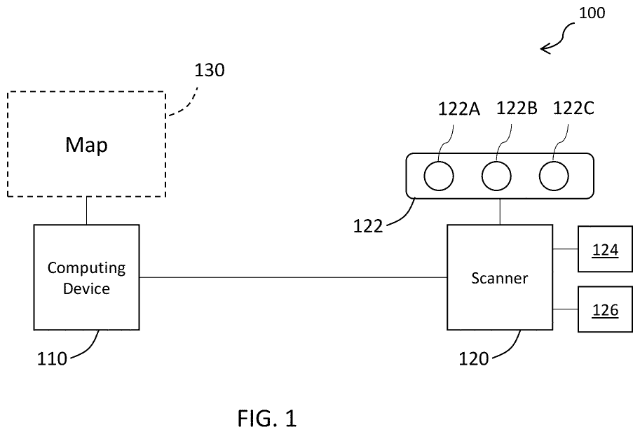

FIG. 1 depicts a system for scanning an environment according to one or more embodiments of the present disclosure. The system 100 includes a computing system 110 coupled with a scanner 120. The coupling facilitates wired and/or wireless communication between the computing system 110 and the scanner 120. The scanner 120 can include a 2D scanner, a 3D scanner, or a combination of both. The scanner 120 is capturing measurements of the surroundings of the scanner 120. The measurements are transmitted to the computing system 110 to generate a point cloud 130 of the environment in which the scanner is being moved. The point cloud 130 can be generated by combining several scans captured by the scanner 120, each scan captured from a separate scan position. Scan position that is associated with a scan is the position of the scanner 120 in the point cloud 130 when capturing that scan. In some embodiments, the scanner 120 may include a 2D scanner that emits light in a plane. In these embodiments, a two-dimensional or map/floorplan of the environment may be generated.

A technical challenge with such combining of the scans is registering the scans, i.e., arranging the scans in the right orientation, zoom level, etc., so that the scans are aligned to form an accurate replica of the environment. For this purpose targets can be used, which are special points/regions that are reliable reference points with the purpose of improving the data quality of the scans and registering multiple scans. Alternatively, Cloud2Cloud or other types of registration techniques can also be used to register one or more scans with each other. Existing systems use artificial markers for identifying such targets. For example, the artificial marker can be a predetermined label that is placed in the environment, which the operator of the scanner can identify as a target. However, placing such artificial markers can be time consuming, and in some cases impractical if the environment does not allow placement of such markers. Examples of targets include checkerboards, spheres or stickers having a predetermined size.

Embodiments of the present disclosure address such technical challenges with generating the point cloud 130 of an environment by facilitating identification of target points using existing, or “natural” locations from the environment itself, without additional steps requiring placement of artificial markers. The embodiments accordingly improve the point cloud generation process. For example, the embodiments herein facilitate using, as anchor objects, features and objects that have been captured in the point cloud and that are already existing in the environment. Further, different types of features can be used as anchor objects based on what is selected by the operator during scanning.

Anchor object is an object in a captured point cloud, where the anchor object is detectable from a range of viewing directions, distances, and orientations. An anchor object is stored in the data captured by the scanner 120 by storing one or more positions, orientations, degrees of freedom, and other measurements of the scanner 120 when capturing the anchor object. Different types of anchor objects provide different constraints in different degrees of freedom when matching two or more instances of the anchor objects in different point clouds. In one or more embodiments of the present invention, anchor objects of the same type can facilitate using the same constraint type. For example, an intersection of three planes can provide position and orientation for six degrees of freedom of the scanner 120 (6dof). Alternatively, a well-defined texture on a plane or other defined geometry (e.g. coded marker, checkerboard, QR code, projected light pattern) can also be used as the anchor object, with potentially reduced dof depending on the object type. Alternatively still, a sphere or other 3D objects, a single plane, or a line (intersection of two planes), can also be used.

By facilitating identification of such features as anchor objects, embodiments of the present disclosure provide several advantages and improvements over existing scanning systems and processes. Such improvements include, but are not limited to, improvements to registration within a single scan, improvements to re-finding of trajectory of the scanner 120 within and during scans (move back to a location from where an anchor object can be captured when tracking has been lost; or determine location based on a capture of an anchor object), and improvements to registration of point clouds from a scan, or from multiple scans with each other. The registration of multiple scans can be performed with or without “snap-in” functionality. Snap-in facilitates live registration of a new scan with another existing scan during capture of the new scan. Further, in one or more embodiments, registration of multiple scans can include registering a first scan that is captured by a first scanner with a second scan that is captured by a second scanner. The scans can be from different types of scanners, such as FREESTYLE®, FOCUS®, etc. The registration of the multiple scans and/or point clouds can be done offline in one or more embodiments of the present invention. Alternatively, in one or more embodiments of the present invention, aligning the point clouds can be performed substantially in real-time, as the data is being captured by the scanner 120.

Anchor objects can be defined during scanning, for example, when scanning an area, part of which, does not have 3D geometry or textures that facilitate the scanner to orient itself in 3D space. For example, such an area can include a flat wall with few textures that is to be scanned by the scanner 120. In such cases the scanner 120 can set an anchor object by defining a location in space where there are sufficient features or 3D geometry, scan the wall, and come back to scan the anchor object. The parts of the scan after returning to the anchor object do not suffer from loss in quality of tracking when scanning the wall. The anchor objects are used for loop closure that facilitates compensating for any loss in quality during the scanning. It should be noted that the above scenario is one example case, and that embodiments from the present disclosure can be used in various other scenarios with other anchor objects. Also, apart from a wall, there are other elements/objects that pose a challenge for scanning. As discussed herein, the location of the anchor object does not need to be a natural location (e.g. a corner), but rather may be a point in space that is defined by locations within the environment, such as the intersection of three nonconnected planes that define a point in space for example.

The anchor object can be selected by an operator manually in one or more embodiments. Alternatively, in one or more embodiments, the anchor object is automatically selected by the scanner 120 based on identification of a natural feature or object from a predetermined list. For example, the scanner 120 continuously monitors the captured frames to detect the presence of one or more natural features from a list of features that have been identified as those that can be used to identify anchor objects. Examples of features that can be used for identifying anchor objects include: planes, lines, 3D points, markers of different types (coded marker, checkerboards, QR code, etc.), projected light patterns, natural texture features, spheres and other 3D objects, columns, and combinations thereof. In yet other embodiments, the anchor object can be detected semi-automatically, where the scanner 120 generates and provides feedback that identifies an object/feature in the frame that is being captured as a potential anchor object. The operator can subsequently select the feature as an anchor object.

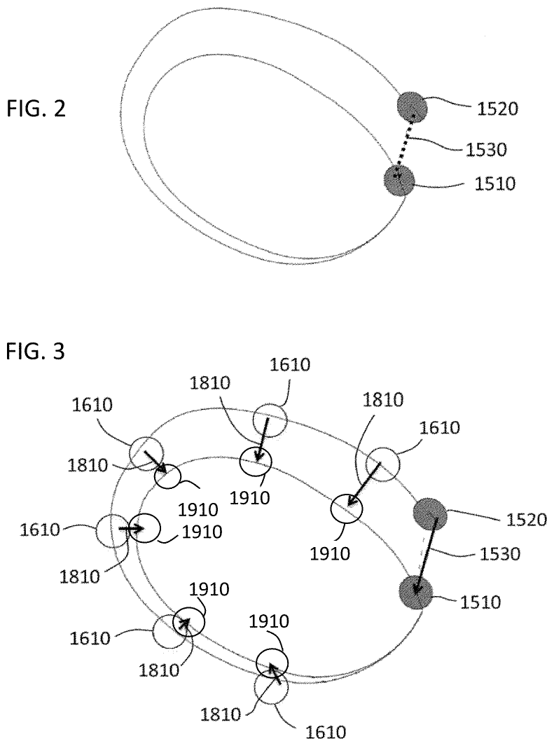

In one or more embodiments of the present invention, the anchor objects are used to perform a loop closure algorithm to determine and compensate for any error (“drift”) that can accumulate as the scanner 120 travels along a trajectory/path. FIG. 2 schematically illustrates an example scenario in which an offset (referred to as “drift”) is continuously introduced into the scan data. Consider that the scanner 120 is moving from a starting position 1510 (real pose). After some movements the scanner 120 is designated to return to an already mapped region, such as the starting position 1510, however the measured position due to sensor variation and the subsequent measurement error is a different position 1520 (estimated pose). The loop closure algorithm(s) that are typically used, include detecting the loop closure correction 1530 and correcting the pose and the point clouds that have been acquired so far by the scanner 120. As a consequence all positions in the point cloud 130, including the scan position, such as 1510, the registration points, and the points scanned and stored in the scans, change their coordinates based on the loop closure correction 1530. Embodiments described herein facilitate using the anchor objects during scanning to perform the loop closure, i.e., to correct for the distance 1530 between the two positions.

For example, FIG. 3 illustrates the accumulation of errors and inefficiencies and how to formulate the pose graph based problem in 2-Dimensions with relative pose constraints. It should be noted that the techniques described herein are not limited to 2D, and can be expanded to 3D. Consider the scanner 120 moving in a 2-Dimensional plane, as depicted in FIG. 3. The scanner 120 has access to a set of sensors such as an inertial measurement unit and a 3D sensor. From these raw measurements, the scanner 120 estimates the trajectory of the scanner 120 as well as builds a map 130 of the environment. In order to reduce the computational complexity of the problem, the pose graph approach abstracts the raw measurements. Specifically, it creates a graph of nodes which represent the pose of the scanner 120, and edges which represent the relative transformation (delta position and orientation) between the two nodes. The edges are virtual measurements derived from the raw sensor measurements, e.g. by integrating the raw wheel odometry or aligning the laser range scans acquired from the scanner 120.

A visualization of the resulting graph is shown in FIG. 3. Consider that in FIG. 3, the pose of the scanner 120 is represented as the circles, the measurements are indicated by the connecting lines, and the loop closure measurements are shown as dotted lines. Loop closures are measurements between non-sequential states and they reduce the accumulation of error over time. The following describes the mathematical formulation of the pose graph problem.

The scanner 120 at timestamp t has state xₜ=[p^{T},ψ]^{T} where p is a 2D vector that represents the position in the plane and w is the orientation in radians. The measurement of the relative transform between the scanner state at two timestamps a and b is given as: z_{ab}=[\hat{p}_{ab}^{T}, \hat{ψ}_{ab}^{T}].

Computation of the error between the measurement and the predicted measurement is:

$${r}_{ab} = [ \begin{matrix}{R}_{a}^{T} ( {p}_{b} - {p}_{a} ) - {\hat{p}}_{ab} \\ {ψ}_{b} - {ψ}_{a} - {\hat{ψ}}_{ab}\end{matrix} ] .$$

Here, the orientations can be normalized in the range [−π,π) in one or more embodiments, and R is a rotation matrix given by:

$${R}_{a} = [ \begin{matrix}cos {ψ}_{a} & - s in {ψ}_{a} \\ sin {ψ}_{a} & cos {ψ}_{a}\end{matrix} ] .$$

The same portion of the environment can be scanned from distinct positions. The coordinates of a virtual point, i.e., a point in a first point cloud, that is captured from a first position are compared with coordinates of the same virtual point in a second point that is captured from a second position. The error, i.e., difference, in the coordinates can be computed and used for loop closure. It should be noted that the above calculations are one possible technique for performing loop closure, and that in one or more embodiments of the technical solutions described herein, different calculations can be used. For example, odometry-based calculations can be used for performing the loop closure in some embodiments.

Embodiments herein facilitate performing the loop closure using the anchor objects that are detected using locations in the environment as described herein. The relative observation of an anchor object from the scanner 120 delivers an accurate position information and can correct the position of the scanner 120 in the absolute world and remove absolute inaccuracies accumulated from the mapping process. The more anchor objects (observed with a good accuracy) the better the position accuracy of the scanner 120 and consequently the absolute accuracy of the point cloud 130 scanned by the scanner 120. It should be noted that as used herein, “absolute accuracy” is the accuracy of measurements of a point cloud that is scanned compared to a ground truth. For example, a side wall of a building has a real length of 100 m. The side wall when measured by the scanner 120 is 101.1 m. In this case, there is an absolute error of 1.1 m and an absolute accuracy of >1.1 for distance >100 m. Such kind of errors in the scan positions are mitigated using loop closure.

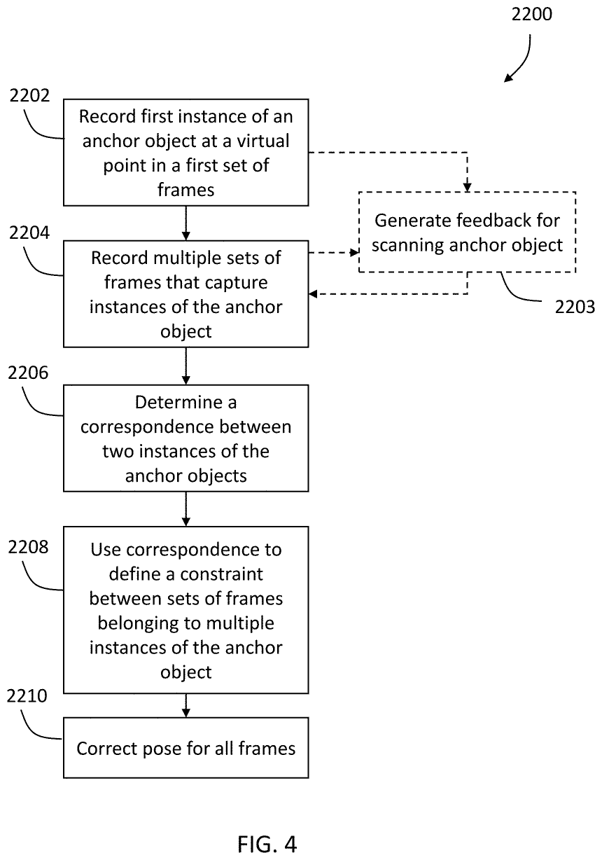

FIG. 4 depicts a flowchart for setting anchor objects and using them for registration improvements according to one or more embodiments. The registration can be done for multiple frames within a single scan in one or more embodiments or for multiple scans. The method includes recording an anchor object in a first set of frames captured by the scanner 120, at block 2202. Consider that the first set of frames is captured during a first time interval t1, and in turn that the anchor object is scanned during the time interval t1. Alternatively, a time interval can be referred to as being centered around a timepoint (e.g., t1, t2, etc.), where the time interval includes several timepoints with the number of timepoints before t1 being the same as the number of timepoints after t1. Further, consider that the scanned instance of the anchor object is a first instance of the anchor object. Recording the anchor object can include the operator pointing the scanner 120 to an anchor object that is defined by one or more natural locations in the environment. The anchor object can be identified using one or more natural features, such as an intersection of three planes, textures, markers, etc. In an embodiment the anchor object may be defined in response to an operator input on a user interface. In one or more embodiments, the scanner 120 records the anchor object in response to the operator performing a predetermined gesture with the scanner 120. The predetermined gesture can be to move the scanner in a particular pattern, for example, infinity sign, plus sign, specific number (e.g., 2, 3 etc.) side swipes, or any other such predetermined gesture. The gesture can include pressing or touching a button on the scanner 120. The button can be a physical button, or a user-interface that is provided via a graphical user-interface. Such gestures can also be used when the anchor object is revisited. In one or more embodiments, two distinct predetermined gestures are used for an initial recording of the anchor object, and subsequent re-recording (or revisits) to the anchor object. Further, each anchor object is assigned a unique identifier, such as a number, a hash-code, or any other unique character string.

It should be noted that for multiple planes to be used to identify an anchor object, the planes need to have a minimum angle with respect to one another, for example, for their intersection point to be used as the anchor object. While orthogonal planes are depicted in the examples in the figures herein, in other embodiments, the planes may not be orthogonal with respect to each other. Also, although intersections of planes are depicted and described as the anchor object in the embodiments described herein, in other embodiments, examples of features that can be used for identifying anchor objects include: planes, lines, 3D points, markers of different types coded marker, checkerboards, QR code, etc.), projected light patterns, natural texture features, spheres and other 3D objects, and combinations thereof.

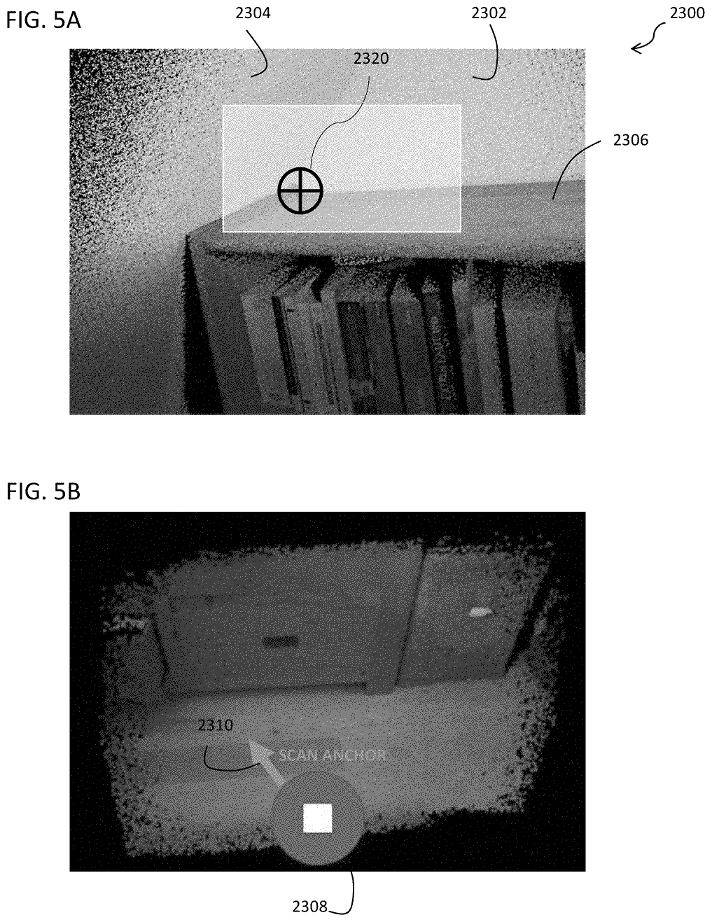

FIG. 5A depicts an example anchor object according to one or more embodiments. In an environment 2300, such as a room, the anchor object 2320 is selected where three planes intersect with each other. The three planes in the anchor object 2320 include two walls 2302, 2304 of a room, and a top surface 2306 of a book shelf. It should be noted that in other embodiments, anchor objects can be intersections of other types of planes. The anchor object 2320 can be defined by a virtual intersection point.

Referring to the flowchart in FIG. 4 of the method 2200, recording the anchor object 2320 can include detecting the anchor object 2320 by the scanner 120. In one or more embodiments, the detection can be automatic. For example, upon determining that the operator is pointing to a predetermined feature that identifies an anchor object, such as an intersection of three planes, for at least a predetermined duration, for example, 2 seconds, 3 seconds, etc., the scanner 120 deems that the feature, (in this case, the intersection) is to be used as an anchor object 2320. Accordingly, position coordinates of the feature, i.e., the intersection, in the point cloud are determined and stored and linked with the anchor object 2320. The “anchor object” identifies a position of a virtual point that is selected and defined by the combination of features (e.g., planes) that can be identified in multiple sets of frames of a scan. For example, in a scan that includes several frames, the anchor object can be initially identified in frames 50-100, and recaptured in frames 300-350. Here, the frame-numbers indicate a sequence in which the frames are captured in the scan. It is understood that in other examples, the anchor object can be identified and recaptured in different frame sets, in a more frequent or a less frequent manner, than the above example.

Alternatively, in an embodiment, the detection of the anchor object 2320 can be semi-automatic. Alternatively yet, in another embodiment, the detection can be manual. For example, the operator points the scanner 120 towards an area with three planes, and selects a user interface element to indicate that the anchor object 2320 is being selected. The system 100 defines the virtual intersection point by finding the intersection of three planes. The detection of the planes can be automatic upon the operator providing the user interface command. In another embodiment, the detection of the planes in the frame is done by the operator manually by selecting the three planes in the frame via the user interface.

The scanner 120 continues to capture point clouds in multiple frames at multiple other scan positions and can capture the anchor object 2320, at block 2204. In one or more examples, the scanner 120 saves the positions, i.e., coordinates, of the anchor objects in a data structure such as a list of positions. Every position in the data structure is directly linked to the data structure that is used to store the measurements of the corresponding portion of the environment.

The same anchor object 2320 can be viewed from multiple positions in the map, and accordingly, can be captured in multiple sets of frames and scans by the scanner 120. The presence of the same anchor object in multiple sets of frames and scans, which are captured by the scanner 120, is referred to as instances of the anchor object. Accordingly, multiple sets of frames captured from different positions include separate instances of the anchor object 2320.

That is, in a second frame, captured at a time interval t2, a second instance of the anchor object 2320 can be captured. The second instance can be captured from a second location of the scanner 120. In one or more embodiments of the present invention, the second instance of the anchor object 2320 is captured manually, automatically, or semi-automatically. In one or more embodiments of the present invention, the scanner device 120 triggers the capture of the second instance of the anchor object 2320 based on one or more anchor-recording criterion, at block 2203. Triggering the capture of the second instance of the anchor object 2320 can include providing a feedback to the scanner device 120 to automatically reorient itself to capture the second instance. Alternatively, the feedback can be communicated to the operator to cause such a reorientation and capture of the second instance.

The anchor-recording criterion is based at least in parts on one or more of the following: time difference between time interval t1 and time interval t2, a number of tracking features that the scanner 120 has captured/recorded so far; a number of anchor objects that the scanner 120 has captured/recorded so far; the age of the anchor object 2320; a number of 3D points that the scanner 120 has captured in the set of frames or in the point cloud; the linear and rotational velocity and acceleration of the scanner 120; the spatial separation between the first and the second part of the point cloud, where the first part includes the first instance of the anchor object 2320, and the second part includes the second instance of the anchor object 2320. The age of an anchor object 2320 indicates a number of consecutive frames that have passed since the anchor object 2320 was detected. Typically, the greater the age, the more helpful it is to re-capture the anchor object for a good point cloud alignment.

In one or more embodiments of the present invention, the movement of the scanner 120, particularly when the movement of the scanner 120 is automatically controlled is guided towards the second instance of the anchor object 2320 based on the anchor-recording criterion. Alternatively, or in addition, the feedback is displayed on a user-interface of the scanner 120. Accordingly, the operator receives the feedback that indicates that an anchor object 2320 has to be captured to improve the quality of the ongoing scan. In one or more embodiments of the present invention, the feedback also includes a guidance to the anchor object 2320 that can be scanned.

FIG. 5B depicts an example guidance provided to scan an anchor object during scanning according to one or more embodiments. Here, a notification 2308 can be displayed that provides feedback to the operator that one or more of the anchor-recording criterion have been met for scanning an instance of an anchor object, which can be the anchor object 2320, or any other anchor object that the scanner 120 has scanned earlier. The notification 2308 can be accompanied by a guidance 2310 that indicates a change in direction/orientation of the scanner 120 to be able to scan an instance of the anchor object 2320. For example, if it has been more than 15 seconds (or any other predetermined duration) since scanning a previous instance of an anchor object, the notification 2308 is provided to the scanner 120 to cause a second (or another) instance of the anchor object. The guidance 2310 can also be provided. Alternatively, or in addition, the notification 2308 is provided when another anchor-recording criterion is met. For example, if a number of frames, or points captured by the scanner 120 since the previous instance of the anchor objects exceeds a predetermined threshold, the notification 2308 is provided.

The scanner 120 can change orientation or distance from when the first instance of the anchor object 2320 was captured. Accordingly, points captured between the time intervals t1 and t2 can have different orientations and/or distances of scanner with respect to anchor object 2320. Further, the points captured between the first time interval t1 can have different orientations and/or distances with respect to the anchor object 2320 compared to the points captured during the second time interval t2.

Referring to the flowchart in FIG. 4, the method 2200 further includes using the instances of anchor object 2320, to determine a correspondence between two or more instances of the anchor objects, at block 2206. Correspondence between first and second instances of the anchor object can be based on an identifier detected in at least one of the first instance and the second instance of the anchor object. Alternatively, or in addition, the correspondence can be based on at least one of their spatial coordinates in the point cloud. In one or more embodiments of the present invention, the spatial coordinates of the instances of the anchor objects can be compared using a maximum distance threshold between the scanner 120 and the anchor object 2320. The correspondence can also be based on at least one of their rotation angles in the point cloud. The rotation angles of the first and second instances of the anchor object can compared using a maximum angular distance threshold in one or more embodiments of the present invention. Alternatively, or in addition, the correspondences between first and second instances of the anchor object 2320 can be based at least in parts on a consistency criterion (e.g. two planes intersecting with one another). In other embodiments, the correspondence between can be based at least in parts on identical features in surroundings. The correspondence can also be based on a unique combination of features (e.g. three planes with defined angles relative to each other).

The correspondence can be used to define a pose constraint of the scanner 120 in one or more embodiments of the present invention. The pose constraint can be defined using the positions and orientations of the instances of the anchor object 2320 and one or more parameters of the scanner 120, for example, orientation, center of gravity, or any other such measured value of the scanner 120. The one or more parameters used to define the constraint can depend on the type of anchor object 230. The constraint that is determined is in addition to other constraints such as planes that are automatically identified during scanning.

There are many different types of constraints defined, e.g., based on texture features or planes that are detected in single frames. In one or more embodiments, the difference in position and orientation between the two instances of the anchor object 2320 in two separate sets of frames can lead to a constraint that sets this difference to zero. The measurement error is computed based on the same anchor object 2320 being viewed in the point cloud captured in two separate sets of frames.

The two separate sets of frames can be captured from distinct poses of the scanner 120. The scanner 120 can automatically identify that the same anchor object 2320 is being viewed again, and initiate the loop closure, in one or more embodiments. Alternatively, the operator can indicate to the scanner 120 that the same anchor object 2320 is being viewed, and to initiate loop closure. For example, specific gestures or user interface elements can be used by the operator to initate the loop closure.

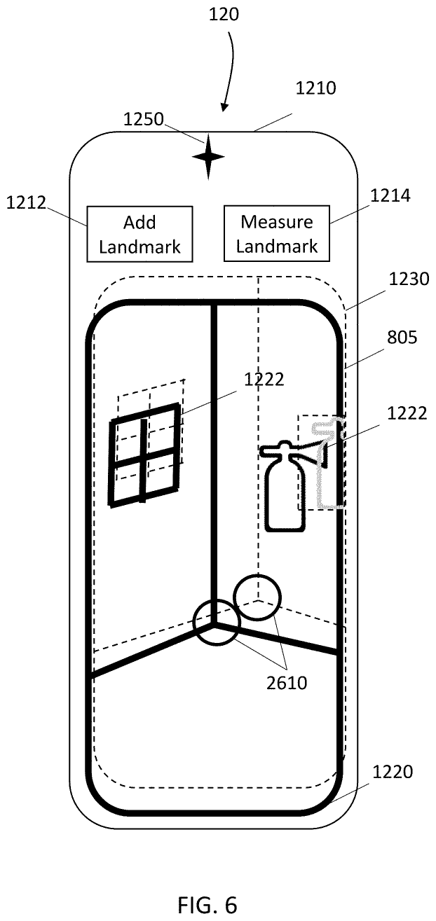

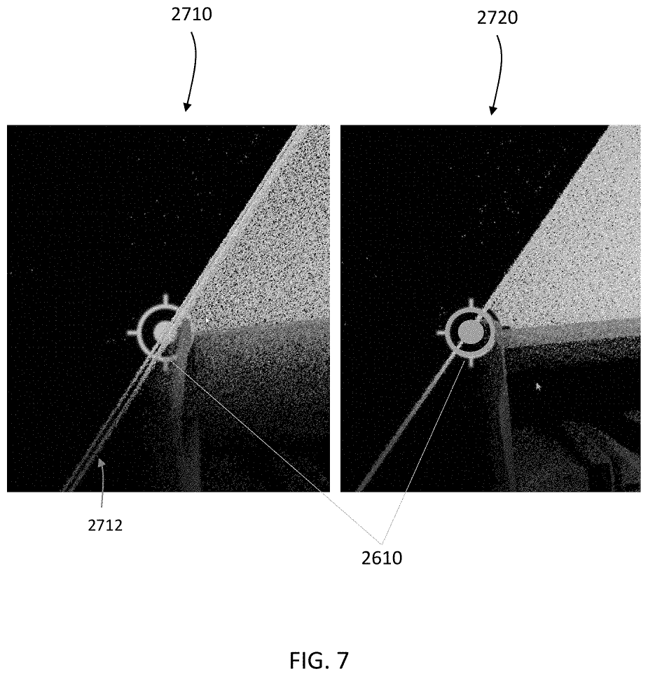

In one or more embodiments of the present disclosure, after moving the scanner 120 to position 1520 (or any other position), the operator selects a “select anchor object” instruction 1214 at the position 1520. In one or more examples, (see FIG. 6) the user interface 1210 depicts to the operator the original view (e.g., photo/image) 1220 that was captured by the scanner 120 when the anchor object 2320 was recorded. A present view 1230 from the scanner 120 is overlaid on the original image 1220 in a transparent manner. The operator can move the scanner 120 until the present view 1230 substantially matches the original image 1220 in the overlay. Once the operator indicates that the overlays match, the system records a relative observation of the present scan pose 1520 of the scanner 120. Further, in one or more embodiments of the present invention, a user-interface selection marker (“selector”) 2610 is shown to notify that the same anchor object 2320 is being viewed. For example, the selector 2610 changes color when the scanner 120 includes the anchor object 2320. (FIG. 7 shows an example where the selector is initially green (2710), and changes to blue when the same anchor object is being viewed later (2720)).

The difference 1530 between the recorded position of the previous instance of the anchor object 2320 and the present position of the anchor object 2320 is used as the error correction to update and correct the mapping positions, in one or more embodiments. Alternatively, or in addition, the error correction leads to a pose constraint to be used in a bundling algorithm.

The pose constraint(s) that is(are) determined are input into a bundling algorithm that provides a position and orientation estimate for each frame that is captured by the scanner 120, at block 2208. The bundling algorithm provides modeling and solving optimization problems. The bundling algorithm can be used to solve non-linear least squares problems with bounds constraints. Given a set of measured image feature locations and correspondences, the goal of bundle adjustment is to find 3D point positions and camera parameters that minimize the reprojection error. This optimization problem is usually formulated as a non-linear least squares problem, where the error is the squared L2 norm of the difference between the observed feature location and the projection of the corresponding 3D point on the image plane of the camera.

The pose constraints are input to the bundling algorithm as parameters, for example, by storing the pose constraints in an electronic file, which is then input of the bundling algorithm. Alternatively, the pose constraints are input as parameters to one or more function calls in a computer program that implements the bundling algorithm. The bundling algorithm can be accessed via an application programming interface, in one or more embodiments. The bundling algorithm itself can be implemented using techniques that are known or will be developed.

Embodiments herein facilitate identifying and providing inputs to the bundling algorithm. The correction that the bundling algorithm provides is based on the type of anchor object. For example, different degrees of freedom can be corrected with different types of anchor objects. For example, using one plane as anchor object defines 3 degrees of freedom, whereas using three planes to define an anchor object defines all 6 degrees of freedom.

As part of the loop closure, the method 2200 further includes using the measurement error 1530 to correct the frames captured by the scanner 120, at block 2210. The portion of the point cloud 130 that is scanned and stored since capturing the anchor object 2320 in the first frame is updated using the measurement error 1530, in one or more embodiments. In one or more examples, a loop closure operation is executed on the point cloud 130, and parts of the point cloud 130 are corrected in order to match the real pose, which is the starting position 1510, with the estimated pose, which is the different position 1520. The loop closure algorithm calculates a displacement for each part of the point cloud 130 that is shifted using the bundling algorithm. It should be appreciated that while embodiments herein illustrate the loop closure in two dimensions, the loop closure may be performed in three-dimensions as well.

In one or more examples, the scanner 120 determines the anchor objects linked to each portion of the point cloud 130. In one or more examples, a lookup is performed over the data structure that saves the list of anchor objects. The lookup costs a single processor operation, such as an array lookup. The scanner 120 applies the displacement vector for a portion of the point cloud 130 to the corresponding scan positions saved in the data structure and saves the resulting displaced (or revised) scan positions back into the data structure. The scanner 120 computes displaced scan positions for each of the saved scan positions 1610 in the data structure. The procedure can be repeated every time the loop closure algorithm is applied.

The displaced scan positions represent corrected scan positions of the scans that can be used directly without applying further computational expensive point cloud registration algorithms. The accuracy of the scan positions 1610 depends on the sensor accuracy of the scanner 120. As shown in FIG. 3, the displacement vectors 1810 for the portions of the point cloud 130 are determined based on the loop closure operation. The scanner 120 applies the displacement vectors 1810 to the scan positions 1610 linked to the portions of the point cloud 130 by the data structure as described herein. The resulting displaced scan positions 1910 are accordingly calculated by applying the displacement vectors 1810 to the scan positions 1610. The displaced scan positions 1910 are now more accurately located. In other words, after a first instance of the anchor object 2320 is captured, when at some point the anchor object 2320 is re-found (either during or after scanning), a new pose of all frames within a scan is computed, using a combination of all constraints defined by the anchor objects and other constraints that may be defined. The measurement error 1530 is then computed, which is used to correct the error/drift accumulated from walking or moving the scanner 120 around the scanned portion of the environment. The measurement error 1530 can be computed by the scanner 120 and/or the computing system 110. Accordingly, in embodiments herein, the defined constraint improves the quality of the scan sequence that has been captured by the scanner 120.

Alternatively, or in addition, the instances of the anchor object 2320 are used to align point clouds, such as aligning the first part of the point cloud captured at t1 that includes the first instance and the second part of the point cloud captured at t2 that includes the second instance. The alignment of the point cloud is done for one or multiple degrees of freedom based on the anchor object 2320. The alignment of the point clouds is performed based on alignment of the instances of the anchor object 2320.

In one or more embodiments of the present invention, the alignment of the point cloud is based on at least one quality parameter assigned to at least one of the detected instances of the anchor object 2320.

It should be noted that additional anchor objects can be scanned in one or more time intervals, and that the examples described herein describe using only a single anchor object 2320 for explanation purposes. For example, in the time interval t1, along with the anchor object 2320, another anchor object is detected and scanned. The other anchor object can be any other type of anchor object. The other anchor object can be used to align the point cloud(s) in place of, or in addition to the anchor object 2320. In another example, a first instance of the anchor object 2320 is captured at time interval t1, a second instance of the anchor object 2320 is captured at time interval t2, a third instance at the time interval t3, and so on. A combination of two or more of these instances can be used to align parts of the point cloud, or one or more point clouds that are scanned at the respective time intervals.

For example, the third instance of the anchor object 2320 can be detected and included in a second point cloud, different from the first point cloud that included the first and second instances of the anchor object 2320. The method described in FIG. 4 can be used to align the first and second point clouds in one or more embodiments of the present invention. Such alignment also includes identifying at least one correspondence between the third instance of the anchor object 2320 and at least one of the first and second instances of the anchor object 2320. In addition, or alternatively, at least part of the second point cloud is aligned with a part of the first point cloud based on the third instance of the anchor object and at least one of the first and the second instance of the anchor object 2320.

In one or more embodiments of the present invention, the first and second point clouds are captured by the same scanner 120. The alignment can be performed in substantially real-time while the scanner 120 is scanning the environment. Alternatively, the alignment can be performed offline, after the scanning is completed. In other embodiments, the first and second point clouds are captured by two separate scanners 120. In one or more embodiments of the present invention, the two separate scanners are different types of scanners, for example, a FOCUS® scanner and a FREESTYLE® scanner. The alignment of the point clouds can be performed using snap-in functionality in one or more embodiments of the present invention. For example, the snap-in functionality allows the operator to visualize the FOCUS® point cloud while recording a FREESTYLE® point cloud and aligning the two point cloud during the recording process e.g. using one or more anchor objects. FOCUS®.

Further yet, the instances of the anchor object 2320 can be used for colorizing the point cloud that is captured. In one or more embodiments of the present invention, the instances of the anchor object 2320 are visualized in the user-interface during capturing the point clouds, and/or during alignment of the point clouds. The instance of the anchor object 2320 can be visualized using a specific icon, cursor, or any other notation. Further, different instances of the same anchor object 2320 can be depicted using a common notation, e.g., all instances of a one or more processors first anchor object is denoted using a first icon, and all instances of a second anchor object is denoted using a second icon. Alternatively, or in addition, instances of anchor objects are denoted using a same icon regardless of the anchor object they belong to.

In one or more embodiments of the present invention, the visualization of an instance of the anchor object 2320 is modified/revised as the alignment process is performed. For example, a color of the visualization of the instance changes (e.g., from green to blue) as the alignment is performed. In one or more embodiments of the present invention, the visualization attribute is changed to notify that the alignment has been successful.

FIG. 7 depicts a comparison between scans captured with and without anchor objects that are captured according to one or more embodiments. The view 2710 shows a scan without using anchor objects, and the view 2720 shows a scan with using anchor objects. As can be seen the scan 2720 is clearer, i.e., improved, in comparison to the scan 2710. For example, the view 2710 illustrates an offset 2712 when the wall 2304 is scanned a first and second times.

It should be noted that “landmarks,” which are used in existing systems, can be used to define anchor objects, which are used in embodiments herein. Typically, a landmark is a natural feature (e.g., actual intersection of three edges) or artificial targets that are placed in the environment, and is not a virtual point in the point cloud like the anchor object.

By using the anchor object(s), loop closure can be performed during live scanning as described herein. For example, when the area is rescanned, the data from scans are aligned between two (or more) captures of the anchor object 2320. In one or more embodiments, immediately after capturing scans of an area in the vicinity of the anchor object 2320, and returning to the anchor object 2320, the points in the scans captured between the two captures of the anchor object 2320 are aligned. Such alignment can be done prior to viewing the point clouds that are captured. Embodiments herein, can accordingly, facilitate tracking re-find for the scanner 120. The operator can re-orient the scanner 120 to identify its position in the environment, by re-scanning the anchor object 2320 and determining the pose of the scanner 120 using the bundling algorithm as described herein. (see FIG. 4).

The anchor objects that are selected and recorded can be of various type and quality. It is possible to use a quality parameter of an anchor object to define the weight of an anchor object with respect to other anchor objects or bundling constraints. The quality parameter indicates a noise level and/or a confidence level associated with an anchor object. For example, if the anchor object is captured in a frame with noise level below a predetermined threshold, the quality parameter associated with that instance of anchor object is higher than the quality parameter assigned to an instance of the anchor object in a frame that has noise level above the predetermined threshold. The noise level can be caused by several factors including, ambient lighting, reflectance of surface(s), stability of the scanner, ranging noise, and so on. The quality parameter can be associated automatically by the scanner based on the noise level in the frame. Alternatively, the quality parameter is user defined by the operator. In one or more embodiments, only instances of the anchor object with at least a predetermined level of quality parameter are used for performing loop closure.

Also, different types of anchor objects define different constraints (e.g. a combination of three planes defines all 6 degrees of freedom, two planes only 5 degrees of freedom, one plane only 3 degrees of freedom). Examples of anchor objects include planes, lines, 3D points, markers of different types (FREESTYLE® marker, checkerboards, QR code, etc.), projected light patterns, natural texture features, and possible combinations thereof.

It should be noted that although the method 2200 is described to capture one anchor object 2320, in other embodiments, multiple anchor objects can be captured and used as described herein.

Further, if the same anchor object is detected in multiple scans, the anchor object is used as a constraint for matching of the multiple scans, for example during stitching the scans. The anchor objects are also used for initialization to generate submaps consisting of multiple matched data. This matching maybe implemented as nonlinear optimization with a cost function. In this method, multiple scans are captured as described in FIG. 4, with frames within each scan being corrected/updated using the anchor objects within each of the frames. Additionally, two or more scans can use the same anchor object 2320. For example, a corner in a room can be used as an anchor object for a first scan that captures a first portion (e.g., one wall) of the room, as well as for a second scan that captures a second portion (e.g., a different wall) of the room. The two scans (which each include multiple frames) are then registered with each other using the anchor object 2320 that is common to both scans.

Additionally, the anchor objects can be reused as indicator for loop closure in the case where the anchor objects can be identified globally e.g. line/wall segments through their length. If multiple such anchor objects are identified between two submaps the loop closure can be evaluated using the timestamp and the anchor objects for the alignment of the multiple submaps.

In one or more embodiments of the present disclosure, the computing device 110 and/or a display (not shown) of the scanner 120 provides a live view of the point cloud 130 of the environment being scanned by the scanner 120 using the set of sensors 122. Point cloud 130 can be a 2D or 3D representation of the environment seen through the different sensors. Point cloud 130 can be represented internally as a grid map. A grid map is a 2D or 3D arranged collection of cells (2D) or voxels (3D), representing an area of the environment. In one or more embodiments of the present disclosure, the grid map stores for every cell/voxel, a probability indicating if the cell area is occupied or not. Other representations of the map 130 can be used in one or more embodiments of the present disclosure.

Embodiments of the present disclosure facilitate improvements to results of loop closure, and consequently an improved scanning system for generating maps of an environment.

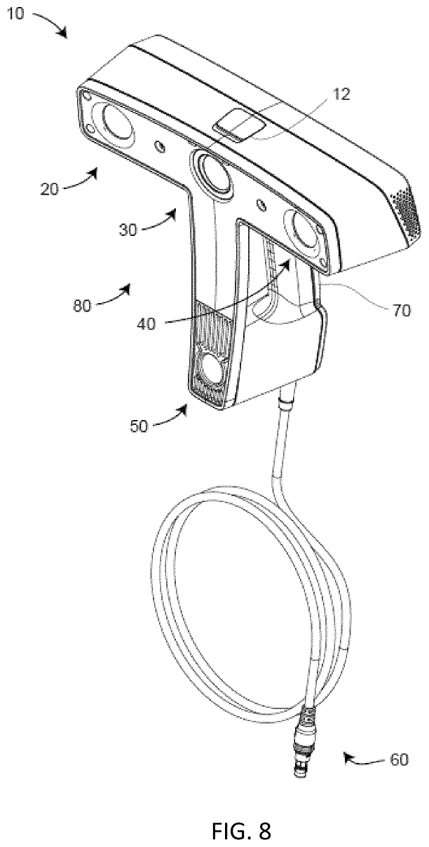

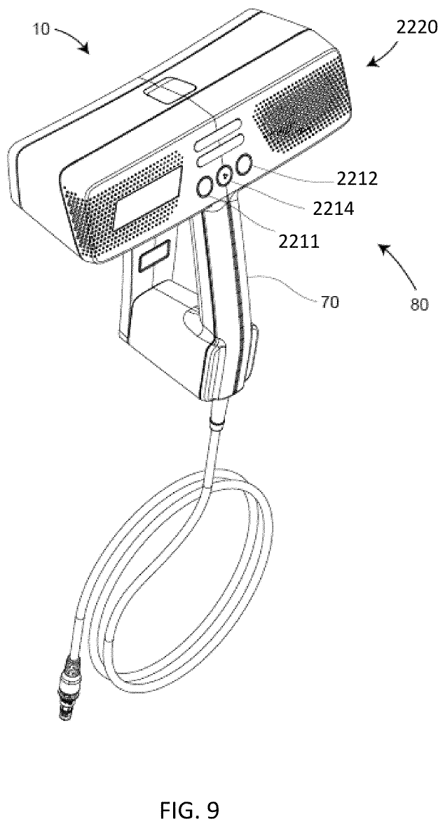

FIG. 8 is a front isometric view of a handheld 3D triangulation scanner 10, also referred to as a handheld 3D imager. In an embodiment, the scanner 10 includes a first infrared (IR) camera 20, a second IR camera 40, a registration camera 30, a projector 50, an Ethernet cable 60 and a handle 70. In an embodiment, the registration camera 30 is a color camera. Ethernet is a family of computer networking technologies standardized under IEEE 802.3. The enclosure 80 includes the outmost enclosing elements of the scanner 10, as explained in more detail herein below. FIG. 9 is a rear perspective view of the scanner 10 further showing an exemplary perforated rear cover 2220 and a scan start/stop button 2214. In an embodiment, buttons 2211, 2212 may be programmed to perform functions according to the instructions of a computer program, the computer program either stored internally within the scanner 10 or externally in an external computer. In an embodiment, each of the buttons 2214, 2211, 2212 includes at its periphery a ring illuminated by a light emitting diode (LED).

In an embodiment, the scanner 10 of FIG. 1 is the scanner described in commonly owned U.S. patent application Ser. No. 16/806,548 filed on Mar. 2, 2020, the contents of which are incorporated by reference herein in its entirety.

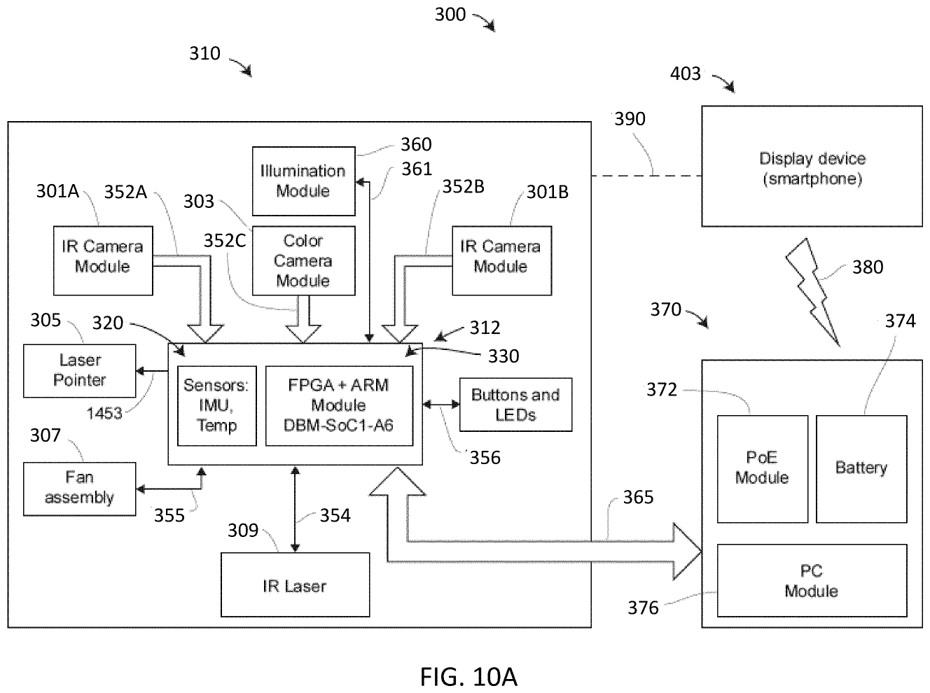

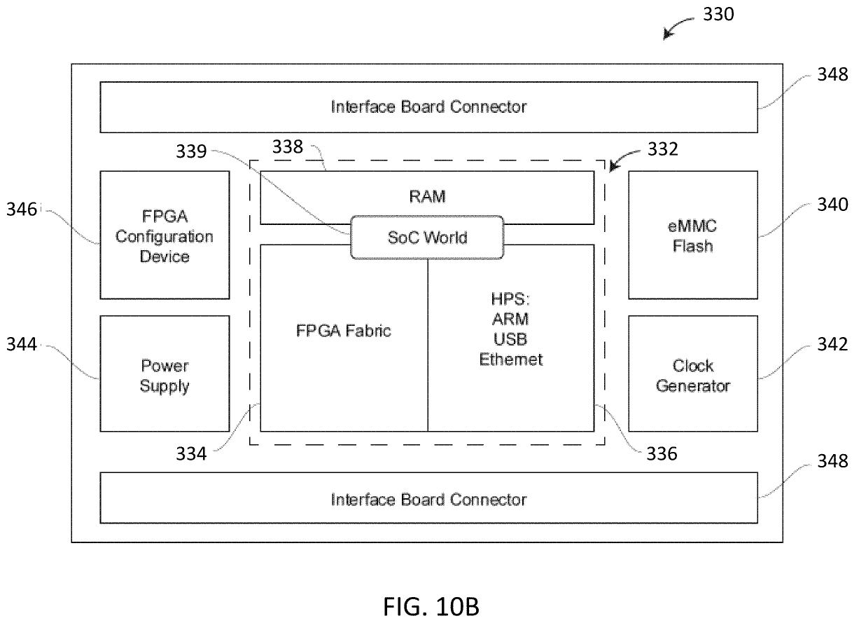

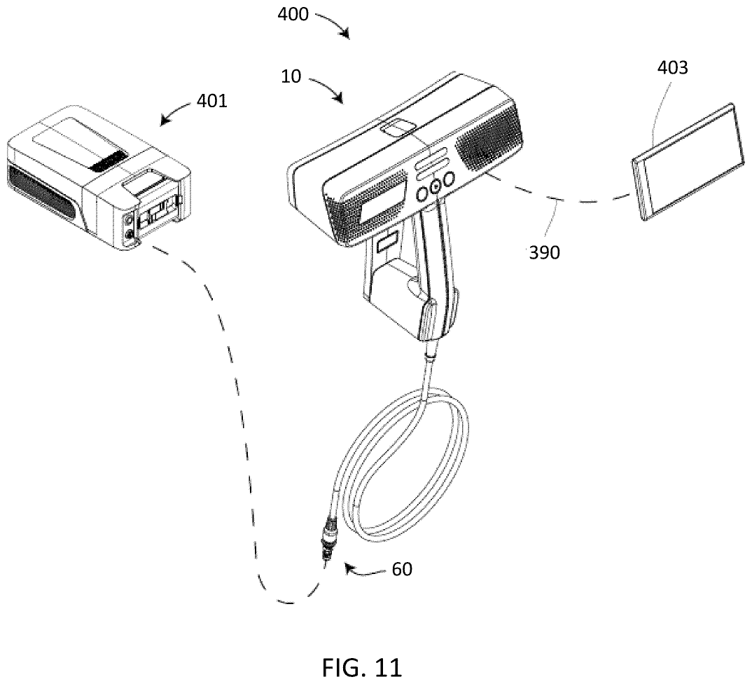

FIG. 10A is a block diagram of system electronics 300 that in an embodiment is included in the scanner system 10. In an embodiment, the electronics 300 includes electronics 310 within the handheld scanner 10, electronics 370 within the mobile PC 401 (FIG. 11), electronics within the mobile computing device 403, electronics within other electronic devices such as accessories that attach to an accessory interface (not shown), and electronics such as external computers that cooperate with the scanner system electronics 300. In an embodiment, the electronics 310 includes a circuit baseboard 312 that includes a sensor collection 320 and a computing module 330, which is further shown in FIG. 10B. In an embodiment, the sensor collection 320 includes an IMU and one or more temperature sensors. In an embodiment, the computing module 330 includes a system-on-a-chip (SoC) field programmable gate array (FPGA) 332. In an embodiment, the SoC FPGA 332 is a Cyclone V SoC FPGA that includes dual 800 MHz Cortex A9 cores, which are Advanced RISC Machine (ARM) devices. The Cyclone V SoC FPGA is manufactured by Intel Corporation, with headquarters in Santa Clara, Calif. FIG. 10B represents the SoC FPGA 332 in block diagram form as including FPGA fabric 334, a Hard Processor System (HPS) 336, and random access memory (RAM) 338 tied together in the SoC 339. In an embodiment, the HPS 336 provides peripheral functions such as Gigabit Ethernet and USB. In an embodiment, the computing module 330 further includes an embedded MultiMedia Card (eMMC) 340 having flash memory, a clock generator 342, a power supply 344, an FPGA configuration device 346, and interface board connectors 348 for electrical communication with the rest of the system.

Signals from the infrared (IR) cameras 301A, 301B and the registration camera 303 are fed from camera boards through cables to the circuit baseboard 312. Image signals 352A, 352B, 352C from the cables are processed by the computing module 330. In an embodiment, the computing module 330 provides a signal 353 that initiates emission of light from the laser pointer 305. A TE control circuit communicates with the TE cooler within the infrared laser 309 through a bidirectional signal line 354. In an embodiment, the TE control circuit is included within the SoC FPGA 332. In another embodiment, the TE control circuit is a separate circuit on the baseboard 312. A control line 355 sends a signal to the fan assembly 307 to set the speed of the fans. In an embodiment, the controlled speed is based at least in part on the temperature as measured by temperature sensors within the sensor unit 320. In an embodiment, the baseboard 312 receives and sends signals to buttons 2214, 2211, 2212 and their LEDs through the signal line 356. In an embodiment, the baseboard 312 sends over a line 361 a signal to an illumination module 360 that causes white light from the LEDs to be turned on or off.

In an embodiment, bidirectional communication between the electronics 310 and the electronics 370 is enabled by Ethernet communications link 365. In an embodiment, the Ethernet link is provided by the cable 60. In an embodiment, the cable 60 attaches to the mobile PC 401 through the connector on the bottom of the handle. The Ethernet communications link 365 is further operable to provide or transfer power to the electronics 310 through the user of a custom Power over Ethernet (PoE) module 372 coupled to the battery 374. In an embodiment, the mobile PC 370 further includes a PC module 376, which in an embodiment is an Intel® Next Unit of Computing (NUC) processor. The NUC is manufactured by Intel Corporation, with headquarters in Santa Clara, Calif. In an embodiment, the mobile PC 370 is configured to be portable, such as by attaching to a belt and carried around the waist or shoulder of an operator.

In an embodiment, shown in FIG. 11, the scanner 10 may be arranged in a first configuration 400. In this embodiment, a display 403, such as a mobile computing device or cellular phone may be configured to communicate with the scanner 10 or the mobile computing device or mobile PC 401. The communication between the display device 403 and the mobile PC 401 may be by cable or via a wireless medium (e.g. Bluetooth™ or WiFi). In an embodiment, a USB cable connects the mobile phone to the scanner 10, for example, through a USB cable 490 to a compatible USB port on the bottom of the main body of the scanner 10. In an embodiment, using USB tethering, the mobile display 403 is connected to the mobile PC 401 by the Ethernet cable 60 that provides Ethernet link 365.

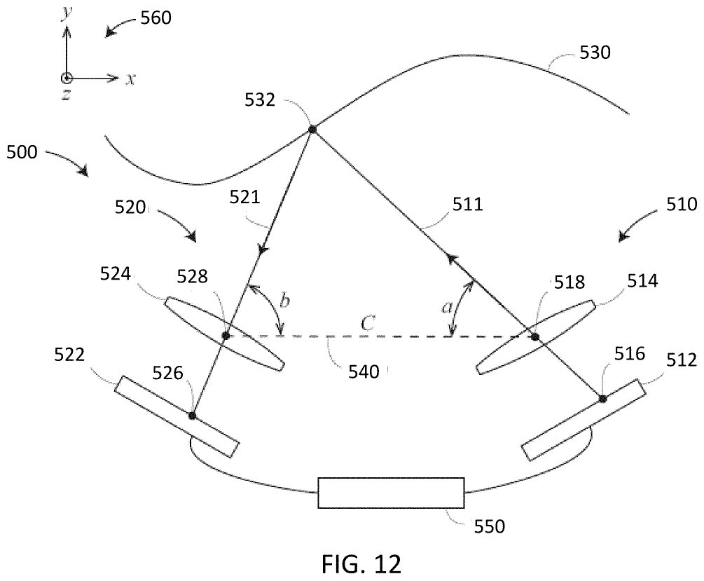

FIG. 12 shows a triangulation scanner (3D imager) 500 that projects a pattern of light over an area on a surface 530. The scanner 500, which has a frame of reference 560, includes a projector 510 and a camera 520. In an embodiment, the projector 510 includes an illuminated projector pattern generator 512, a projector lens 514, and a perspective center 518 through which a ray of light 511 emerges. The ray of light 511 emerges from a corrected point 516 having a corrected position on the pattern generator 512. In an embodiment, the point 516 has been corrected to account for aberrations of the projector, including aberrations of the lens 514, in order to cause the ray to pass through the perspective center 518, thereby simplifying triangulation calculations. In an embodiment, the pattern generator 512 includes a light source that sends a beam of light through a diffractive optical element (DOE). For example, the light source might be the infrared laser 309. A beam of light from the infrared laser 309 passes through the DOE, which diffracts the light into a diverging pattern such as a diverging grid of spots. In an embodiment, one of the projected rays of light 511 has an angle corresponding to the angle a in FIG. 12. In another embodiment, the pattern generator 512 includes a light source and a digital micromirror device (DMD). In other embodiments, other types of pattern generators 512 are used.

The ray of light 511 intersects the surface 530 in a point 532, which is reflected (scattered) off the surface and sent through the camera lens 524 to create a clear image of the pattern on the surface 530 of a photosensitive array 522. The light from the point 532 passes in a ray 521 through the camera perspective center 528 to form an image spot at the corrected point 526. The position of the image spot is mathematically adjusted to correct for aberrations of the camera lens. A correspondence is obtained between the point 526 on the photosensitive array 522 and the point 516 on the illuminated projector pattern generator 512. As explained herein below, the correspondence may be obtained by using a coded or an uncoded pattern of projected light. Once the correspondence is known, the angles a and b in FIG. 12 may be determined. The baseline 540, which is a line segment drawn between the perspective centers 518 and 528, has a length C. Knowing the angles a, b and the length C, all the angles and side lengths of the triangle 528-532-518 may be determined. Digital image information is transmitted to a processor 550, which determines 3D coordinates of the surface 530. The processor 550 may also instruct the illuminated pattern generator 512 to generate an appropriate pattern.

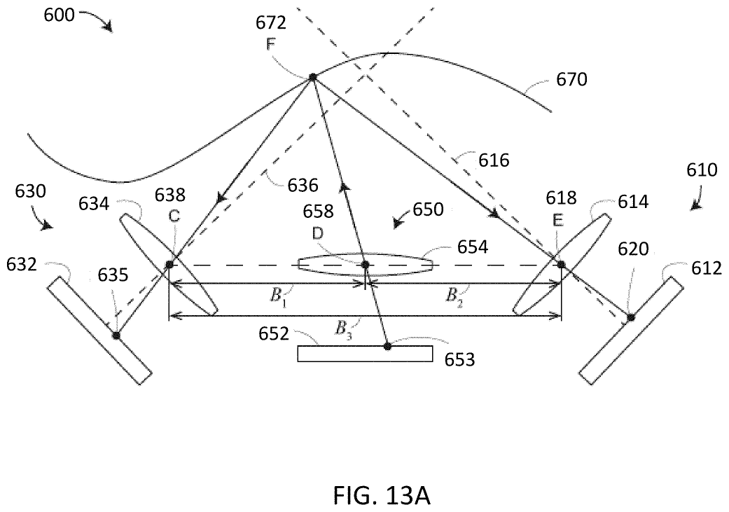

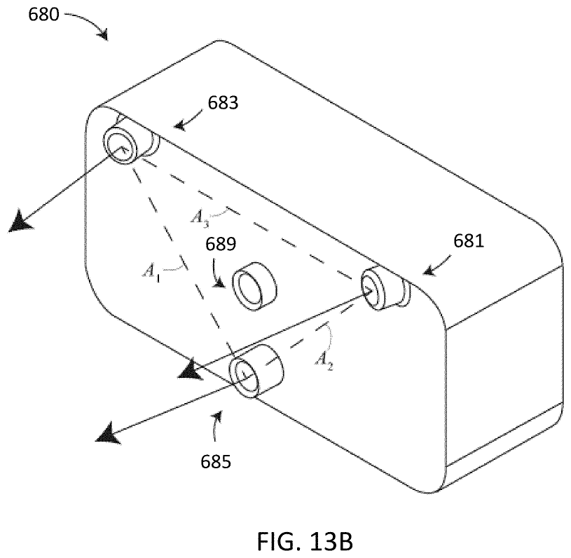

FIG. 13A shows a structured light triangulation scanner 600 having a projector 650, a first camera 610, and a second camera 630. The projector 650 creates a pattern of light on a pattern generator 652, which it projects from a corrected point 653 of the pattern through a perspective center 658 (point D) of the lens 654 onto an object surface 670 at a point 672 (point F). In an embodiment, the pattern generator is a DOE that projects a pattern based on principles of diffractive optics. In other embodiments, other types of pattern generators are used. The point 672 is imaged by the first camera 610 by receiving a ray of light from the point 672 through a perspective center 618 (point E) of a lens 614 onto the surface of a photosensitive array 612 of the camera as a corrected point 620. The point 620 is corrected in the read-out data by applying a correction factor to remove the effects of lens aberrations. The point 672 is likewise imaged by the second camera 630 by receiving a ray of light from the point 672 through a perspective center 638 (point C) of the lens 634 onto the surface of a photosensitive array 632 of the second camera as a corrected point 635. It should be understood that any reference to a lens in this document is understood to mean any possible combination of lens elements and apertures.

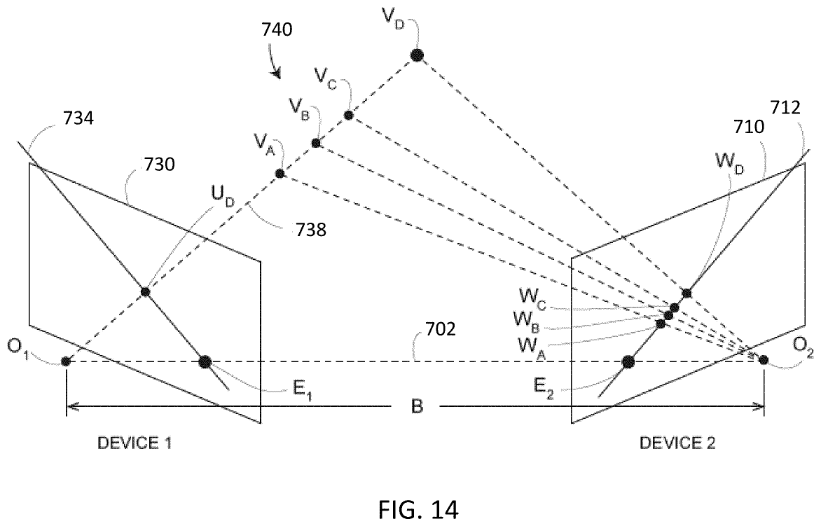

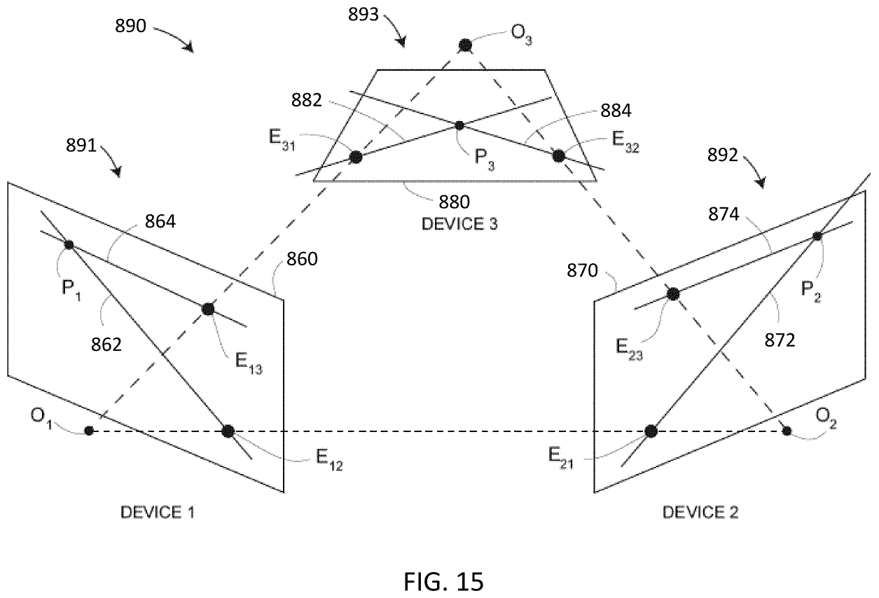

FIG. 13B shows 3D imager 680 having two cameras6, 683 and a projector 685 arranged in a triangle A₁-A₂-A₃. In an embodiment, the 3D imager 680 of FIG. 13B further includes a camera 689 that may be used to provide color (texture) information for incorporation into the 3D image. In addition, the camera 689 may be used to register multiple 3D images through the use of videogrammetry. This triangular arrangement provides additional information beyond that available for two cameras and a projector arranged in a straight line as illustrated in FIG. 13A. The additional information may be understood in reference to FIG. 14, which explains the concept of epipolar constraints, and FIG. 15, which explains how epipolar constraints are advantageously applied to the triangular arrangement of the 3D imager 680. In an embodiment, the elements 681, 683, 685, 689 in FIG. 13B correspond to the elements 40, 20, 50, 30 in FIG. 8.

In FIG. 14, a 3D triangulation instrument 740 includes a device 1 and a device 2 on the left and right sides, respectively. Device 1 and device 2 may be two cameras or device 1 and device 2 may be one camera and one projector. Each of the two devices, whether a camera or a projector, has a perspective center, O₁ and O₂, and a reference plane, 730 or 710. The perspective centers are separated by a baseline distance B, which is the length of the line 702 between 01 and 02. The perspective centers O₁, O₂ are points through which rays of light may be considered to travel, either to or from a point on an object. These rays of light either emerge from an illuminated projector pattern or impinge on a photosensitive array.

In FIG. 14, a device 1 has a perspective center O₁ and a reference plane 2130, where the reference plane 730 is, for the purpose of analysis, equivalent to an image plane of the object point O₁ 730. In other words, the reference plane 730 is a projection of the image plane about the perspective center O₁. A device 2 has a perspective center O₂ and a reference plane 710. A line 702 drawn between the perspective centers O₁ and O₂ crosses the planes 730 and 710 at the epipole points E₁, E₂, respectively. Consider a point UD on the plane 730. If device 1 is a camera, an object point that produces the point UD on the reference plane 730 (which is equivalent to a corresponding point on the image) must lie on the line 738. The object point might be, for example, one of the points V_{A}, V_{B}, V_{C}, or V_{D}. These four object points correspond to the points W_{A}, W_{B}, W_{C}, W_{D}, respectively, on the reference plane 710 of device 2. This is true whether device 2 is a camera or a projector. It is also true that the four points lie on a straight line 712 in the plane 710. This line, which is the line of intersection of the reference plane 710 with the plane of O₁-O₂-UD, is referred to as the epipolar line 712. It follows that any epipolar line on the reference plane 710 passes through the epipole E₂. Just as there is an epipolar line on the reference plane 710 of device 2 for any point UD on the reference plane of device 1, there is also an epipolar line 734 on the reference plane 730 of device 1 for any point on the reference plane 710 of device 2.

FIG. 15 illustrates the epipolar relationships for a 3D imager 890 corresponding to 3D imager 880 of FIG. 90B in which two cameras and one projector are arranged in a triangular pattern. In general, the device 1, device 2, and device 3 may be any combination of cameras and projectors as long as at least one of the devices is a camera. Each of the three devices 891, 892, 893 has a perspective center O₁, O₂, O₃, respectively, and a reference plane 860, 870, and 880, respectively. Each pair of devices has a pair of epipoles. Device 1 and device 2 have epipoles E₁₂, E₂₁ on the planes 860, 870, respectively. Device 1 and device 3 have epipoles E₁₃, E₃₁, respectively on the planes 860, 880, respectively. Device 2 and device 3 have epipoles E₂₃, E₃₂ on the planes 870, 880, respectively. In other words, each reference plane includes two epipoles. The reference plane for device 1 includes epipoles E₁₂ and E₁₃. The reference plane for device 2 includes epipoles E₂₁ and E₂₃. The reference plane for device 3 includes epipoles E₃₁ and E₃₂.

Consider the situation of FIG. 15 in which device 3 is a projector, device 1 is a first camera, and device 2 is a second camera. Suppose that a projection point P₃, a first image point P₁, and a second image point P₂ are obtained in a measurement. These results can be checked for consistency in the following way.

To check the consistency of the image point P₁, intersect the plane P₃-E₃₁-E₁₃ with the reference plane 860 to obtain the epipolar line 864. Intersect the plane P₂-E₂₁-E₁₂ to obtain the epipolar line 862. If the image point P₁ has been determined consistently, the observed image point P₁ will lie on the intersection of the calculated epipolar lines 862 and 864.

To check the consistency of the image point P₂, intersect the plane P₃-E₃₂-E₂₃ with the reference plane 870 to obtain the epipolar line 874. Intersect the plane P₁-E₁₂-E₂₁ to obtain the epipolar line 872. If the image point P₂ has been determined consistently, the observed image point P₂ will lie on the intersection of the calculated epipolar line 872 and epipolar line 874.

To check the consistency of the projection point P₃, intersect the plane P₂-E₂₃-E₃₂ with the reference plane 880 to obtain the epipolar line 884. Intersect the plane P₁-E₁₃-E₃₁ to obtain the epipolar line 882. If the projection point P₃ has been determined consistently, the projection point P₃ will lie on the intersection of the calculated epipolar lines 882 and 884.

The redundancy of information provided by using a 3D imager having three devices (such as two cameras and one projector) enables a correspondence among projected points to be established even without analyzing the details of the captured images and projected pattern features. Suppose, for example, that the three devices include two cameras and one projector. Then a correspondence among projected and imaged points may be directly determined based on the mathematical constraints of the epipolar geometry. This may be seen in FIG. 15 by noting that a known position of an illuminated point on one of the reference planes 860, 870, 880 automatically provides the information needed to determine the location of that point on the other two reference planes. Furthermore, once a correspondence among points has been determined on each of the three reference planes 860, 870, 880, a triangulation calculation may be performed using only two of the three devices of FIG. 15. A description of such a triangulation calculation is discussed in relation to FIG. 14.

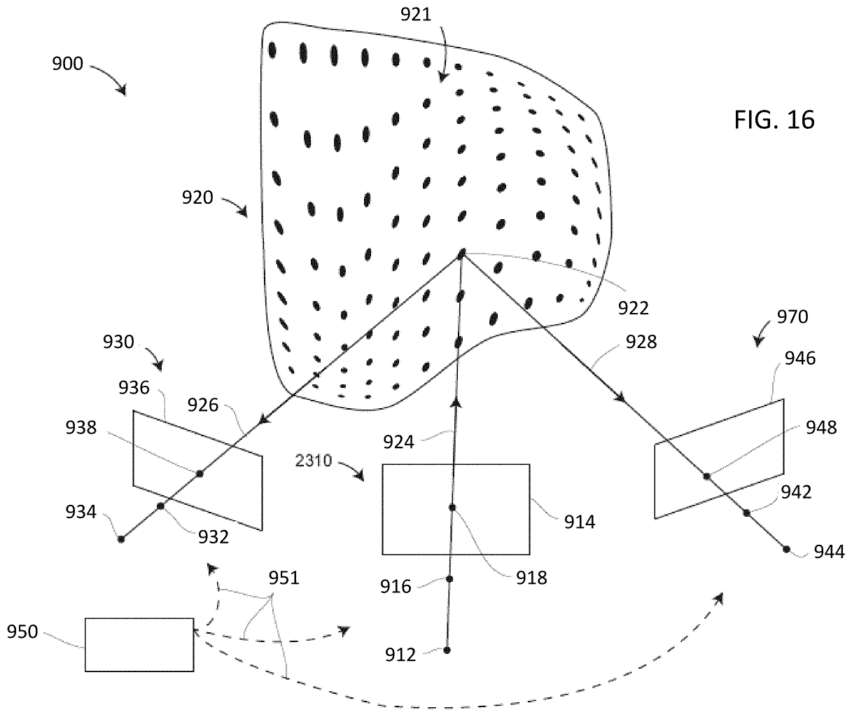

By establishing correspondence based on epipolar constraints, it is possible to determine 3D coordinates of an object surface by projecting uncoded spots of light. An example of projection of uncoded spots is illustrated in FIG. 16. In an embodiment, a projector 910 projects a collection of identical spots of light 921 on an object 920. In the example shown, the surface of the object 920 is curved in an irregular manner causing an irregular spacing of the projected spots on the surface. One of the projected points is the point 922, projected from a projector source element 2312 and passing through the perspective center 916 as a ray of light 924 forms a point 918 on the reference plane 914.

The point or spot of light 922 on the object 920 is projected as a ray of light 926 through the perspective center 932 of a first camera 930, resulting in a point 934 on the image sensor of the camera 930. The corresponding point 938 is located on the reference plane 936. Likewise, the point or spot of light 922 is projected as a ray of light 928 through the perspective center 942 of a second camera 940, resulting in a point 944 on the image sensor of the camera 940. The corresponding point 948 is located on the reference plane 946. In an embodiment, a processor 950 is in communication with the projector 910, first camera 930, and second camera 940. The processor determines a correspondence among points on the projector 910, first camera 930, and second camera 940. In an embodiment, the processor 950 performs a triangulation calculation to determine the 3D coordinates of the point 922 on the object 920. An advantage of a scanner 900 having three device elements, either two cameras and one projector or one camera and two projectors, is that correspondence may be determined among projected points without matching projected feature characteristics. In other words, correspondence can be established among spots on the reference planes 936, 914, and 946 even without matching particular characteristics of the spots. The use of the three devices 910, 930, 940 also has the advantage of enabling identifying or correcting errors in compensation parameters by noting or determining inconsistencies in results obtained from triangulation calculations, for example, between two cameras, between the first camera and the projector, and between the second camera and the projector.

It should be appreciated that while 3D coordinate data may be used for training, the methods described herein for verifying the registration of landmarks may be used with either two-dimensional or three-dimensional data sets.

Technical effects and benefits of the disclosed embodiments include, but are not limited to, increasing scan quality and a visual appearance of scans acquired by the 3D coordinate measurement device.

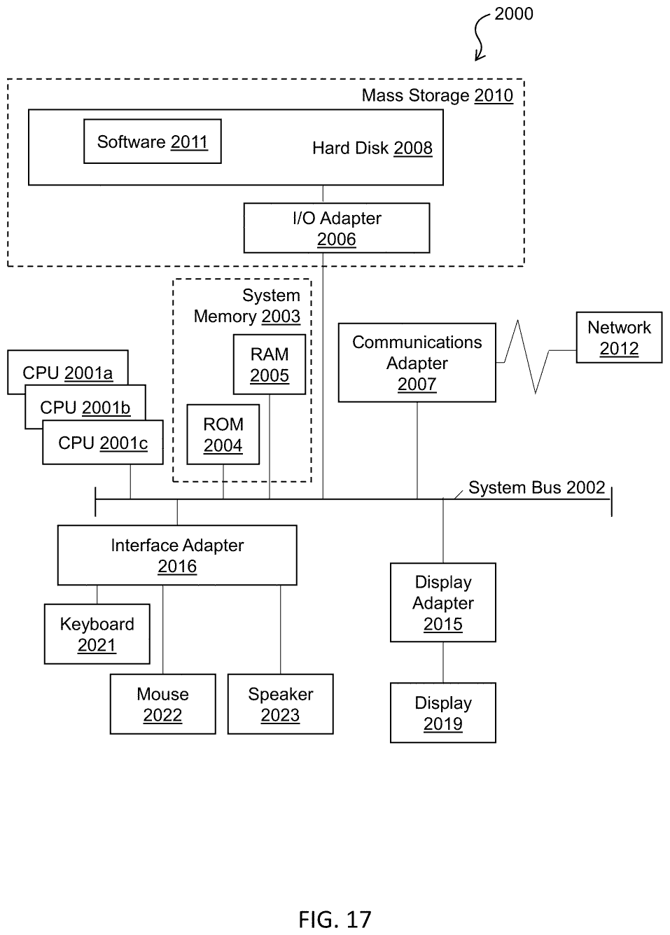

Turning now to FIG. 17, a computer system 2100 is generally shown in accordance with an embodiment. The computer system 2100 can be an electronic, computer framework comprising and/or employing any number and combination of computing devices and networks utilizing various communication technologies, as described herein. The computer system 2100 can be easily scalable, extensible, and modular, with the ability to change to different services or reconfigure some features independently of others. The computer system 2100 may be, for example, a server, desktop computer, laptop computer, tablet computer, or smartphone. In some examples, computer system 2100 may be a cloud computing node. Computer system 2100 may be described in the general context of computer system executable instructions, such as program modules, being executed by a computer system. Generally, program modules may include routines, programs, objects, components, logic, data structures, and so on that perform particular tasks or implement particular abstract data types. Computer system 2100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 17, the computer system 2100 has one or more central processing units (CPU(s)) 2101a, 2101b, 2101c, etc. (collectively or generically referred to as processor(s) 2101). The processors 2101 can be a single-core processor, multi-core processor, computing cluster, or any number of other configurations. The processors 2101, also referred to as processing circuits, are coupled via a system bus 2102 to a system memory 2103 and various other components. The system memory 2103 can include a read only memory (ROM) 2104 and a random access memory (RAM) 2105. The ROM 2104 is coupled to the system bus 2102 and may include a basic input/output system (BIOS), which controls certain basic functions of the computer system 2100. The RAM is read-write memory coupled to the system bus 2102 for use by the processors 2101. The system memory 2103 provides temporary memory space for operations of said instructions during operation. The system memory 2103 can include random access memory (RAM), read only memory, flash memory, or any other suitable memory systems.

The computer system 2100 comprises an input/output (I/O) adapter 2106 and a communications adapter 2107 coupled to the system bus 2102. The I/O adapter 2106 may be a small computer system interface (SCSI) adapter that communicates with a hard disk 2108 and/or any other similar component. The I/O adapter 2106 and the hard disk 2108 are collectively referred to herein as a mass storage 2110.

Software 2111 for execution on the computer system 2100 may be stored in the mass storage 2110. The mass storage 2110 is an example of a tangible storage medium readable by the processors 2101, where the software 2111 is stored as instructions for execution by the processors 2101 to cause the computer system 2100 to operate, such as is described herein below with respect to the various Figures. Examples of computer program product and the execution of such instruction is discussed herein in more detail. The communications adapter 2107 interconnects the system bus 2102 with a network 2112, which may be an outside network, enabling the computer system 2100 to communicate with other such systems. In one embodiment, a portion of the system memory 2103 and the mass storage 2110 collectively store an operating system, which may be any appropriate operating system, such as the z/OS or AIX operating system from IBM Corporation, to coordinate the functions of the various components shown in FIG. 17.

Additional input/output devices are shown as connected to the system bus 2102 via a display adapter 2115 and an interface adapter 2116 and. In one embodiment, the adapters 2106, 2107, 2115, and 2116 may be connected to one or more I/O buses that are connected to the system bus 2102 via an intermediate bus bridge (not shown). A display 2119 (e.g., a screen or a display monitor) is connected to the system bus 2102 by a display adapter 2115, which may include a graphics controller to improve the performance of graphics intensive applications and a video controller. A keyboard 2121, a mouse 2122, a speaker 2123, etc. can be interconnected to the system bus 2102 via the interface adapter 2116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 17, the computer system 2100 includes processing capability in the form of the processors 2101, and, storage capability including the system memory 2103 and the mass storage 2110, input means such as the keyboard 2121 and the mouse 2122, and output capability including the speaker 2123 and the display 2119.

In some embodiments, the communications adapter 2107 can transmit data using any suitable interface or protocol, such as the internet small computer system interface, among others. The network 2112 may be a cellular network, a radio network, a wide area network (WAN), a local area network (LAN), or the Internet, among others. An external computing device may connect to the computer system 2100 through the network 2112. In some examples, an external computing device may be an external webserver or a cloud computing node.

It is to be understood that the block diagram of FIG. 17 is not intended to indicate that the computer system 2100 is to include all of the components shown in FIG. 17. Rather, the computer system 2100 can include any appropriate fewer or additional components not illustrated in FIG. 17 (e.g., additional memory components, embedded controllers, modules, additional network interfaces, etc.). Further, the embodiments described herein with respect to computer system 2100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

It will be appreciated that aspects of the present disclosure may be embodied as a system, method, or computer program product and may take the form of a hardware embodiment, a software embodiment (including firmware, resident software, micro-code, etc.), or a combination thereof. Furthermore, aspects of the present disclosure may take the form of a computer program product embodied in one or more computer-readable medium(s) having computer-readable program code embodied thereon.

One or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In one aspect, the computer-readable storage medium may be a tangible medium containing or storing a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium, and that can communicate, propagate, or transport a program for use by or in connection with an instruction execution system, apparatus, or device.

The computer-readable medium may contain program code embodied thereon, which may be transmitted using any appropriate medium, including but not limited to wireless, wireline, optical fiber cable, RF, etc., or any suitable combination of the foregoing. In addition, computer program code for carrying out operations for implementing aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server.

It will be appreciated that aspects of the present disclosure are described herein with reference to flowchart illustrations and/or block diagrams of methods, apparatus (systems) and computer program products according to embodiments of the invention. It will be understood that each block or step of the flowchart illustrations and/or block diagrams, and combinations of blocks or steps in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

Terms such as processor, controller, computer, DSP, FPGA are understood in this document to mean a computing device that may be located within an instrument, distributed in multiple elements throughout an instrument, or placed external to an instrument.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description but is only limited by the scope of the appended claims.

What is claimed is:

1. A system comprising:
a scanner device configured to capture a set of point clouds comprising 3D points; and
one or more processors operable to:
detect, during the capture of the set of point clouds, at least one first anchor object in a first part of a first point cloud, the first part belonging to first time interval centered at time t1;
detect at least one second anchor object in a second part of the first point cloud, the second part belonging to second time interval centered at time t2;
identify at least one correspondence between the first anchor object and the second anchor object; and
align the first part of the first point cloud with the second part of the first point cloud based on the at least one correspondence between the first anchor object and the second anchor object.

2. The system of claim 1, wherein the one or more processors are operable to determine a pose of the scanner device using the first anchor object.

3. The system of claim 1, wherein the first anchor object is identified using one or more features in the surrounding environment, the one or more features including at least one of: plane, line, sphere, cylinder, texture feature, marker, projected light pattern, and a combination thereof.

4. The system of claim 1, wherein the first anchor object is identified in response to a predetermined gesture performed with the scanner device.

5. The system of claim 1, wherein the one or more processors are further operable to generate a feedback to guide the scanner device to scan an area that includes at last one of the first anchor object and the second anchor object.

6. The system of claim 5, wherein the feedback is generated based on at least one anchor-recording criterion from the following:
i. a time difference between the time interval t1 and the time interval t2;
ii. a number of tracking targets that are recorded by the scanner device;
iii. minimum age of the tracking targets that are recorded;
iv. a number of 3D points that have been captured by the scanner point in the scan;
v. a linear or rotational velocity or acceleration of the scanner device; and
vi. a spatial separation between the first part and the second part.

7. The system of claim 1, wherein the at least one correspondence between the first anchor object and the second anchor object is based on one or more of:
an identifier detected in the first anchor object and the second anchor object;
type of object of the first anchor object and the second anchor object;
spatial coordinates of the first anchor object and of the second anchor object;
rotation angles of the first anchor object and of the second anchor object; and
a consistency criterion associated with the first anchor object and of the second anchor object.

8. The system of claim 1, wherein the first part is aligned with the second part based on a quality criterion associated with the first anchor object and the second anchor object.

9. The system of claim 1, wherein the one or more processors are further operable to:
detect at least one third anchor object in a first part of a second point cloud;
identify at least one correspondence between the third anchor object and the first anchor object; and
align the first point cloud and the second point cloud based on the at least one correspondence between the first anchor object and the third anchor object.

10. The system of claim 9, wherein the scanner device is a first scanner device, and the system further comprises a second scanner device, and wherein the first point cloud is captured by the first scanner device, and the second point cloud is captured by the second scanner device.

11. The system of claim 9, wherein the first point cloud and the second point cloud are registered with each other using snap-in registration.

12. The system of claim 1, wherein the one or more processors are further operable to generate a user-interface to depict the first anchor object, wherein one or more attributes of the user-interface are based on a number of correspondences associated with the first anchor object.

13. The system of claim 12, wherein the attributes of the user-interface are changed in response to aligning the first part with the second part.

14. A method for a scanner device to capture a set of point clouds, each of the point clouds comprising 3D points, the method comprising:
detecting, during the capture of the set of point clouds, at least one first anchor object in a first part of a first point cloud, the first part belonging to first time interval centered at time t1;
detecting at least one second anchor object in a second part of the first point cloud, the second part belonging to second time interval centered at time t2;
identifying at least one correspondence between the first anchor object and the second anchor object; and
aligning the first part of the first point cloud with the second part of the first point cloud based on the at least one correspondence between the first anchor object and the second anchor object.

15. The method of claim 14, further comprising determining a pose of the scanner device using the first anchor object.

16. The method of claim 14, wherein the first anchor object is identified using one or more features in the surrounding environment, the one or more features including at least one of: plane, line, sphere, cylinder, texture feature, marker, projected light pattern, and a combination thereof.

17. The method of claim 14, wherein the first anchor object is identified in response to a predetermined gesture performed with the scanner device.

18. The method of claim 14, further comprising generating a feedback to guide the scanner device to scan an area that includes at last one of the first anchor object and the second anchor object.

19. The method of claim 18, wherein the feedback is generated based on at least one anchor-recording criterion from the following:
i. a time difference between the time interval t1 and the time interval t2;
ii. a number of tracking targets that are recorded by the scanner device;
iii. minimum age of the tracking targets that are recorded;
iv. a number of 3D points that have been captured by the scanner point in the scan;
v. a linear or rotational velocity or acceleration of the scanner device; and
vi. a spatial separation between the first part and the second part.

20. The method of claim 14, wherein the at least one correspondence between the first anchor object and the second anchor object is based on one or more of:
an identifier detected in the first anchor object and the second anchor object;
type of object of the first anchor object and the second anchor object;
spatial coordinates of the first anchor object and of the second anchor object;
rotation angles of the first anchor object and of the second anchor object; and
a consistency criterion associated with the first anchor object and of the second anchor object.

21. The method of claim 14, wherein the first part is aligned with the second part based on a quality criterion associated with the first anchor object and the second anchor object.

22. The method of claim 14, further comprising:
detecting at least one third anchor object in a first part of a second point cloud;
identifying at least one correspondence between the third anchor object and the first anchor object; and
aligning the first point cloud and the second point cloud based on the at least one correspondence between the first anchor object and the third anchor object.

23. The method of claim 22, wherein the scanner device is a first scanner device, and the system further comprises a second scanner device, and wherein the first point cloud is captured by the first scanner device, and the second point cloud is captured by the second scanner device.

24. The method of claim 22, wherein the first point cloud and the second point cloud are registered with each other using snap-in registration.

25. The method of claim 14, further comprising generating a user-interface to depict the first anchor object, wherein one or more attributes of the user-interface are based on a number of correspondences associated with the first anchor object.

26. The method of claim 25, wherein the attributes of the user-interface are changed in response to aligning the first part with the second part.

27. A computer program product comprising a memory device having one or more computer executable instructions stored thereon, the computer executable instructions when executed by one or more processors cause the one or more processors to perform a method for a scanner device to capture a set of point clouds, each of the point clouds comprising 3D points, the method comprising:
detecting, during the capture of the set of point clouds, at least one first anchor object in a first part of a first point cloud, the first part belonging to first time interval centered at time t1;
detecting at least one second anchor object in a second part of the first point cloud, the second part belonging to second time interval centered at time t2;
identifying at least one correspondence between the first anchor object and the second anchor object; and
aligning the first part of the first point cloud with the second part of the first point cloud based on the at least one correspondence between the first anchor object and the second anchor object.

28. The computer program product of claim 27, wherein the first anchor object and the second anchor object are instances of the same anchor object being detected by the scanner device.
